(19) United States
(12) Patent Application Publication
(10) Pub. No.: US 2019/0000259 A1
(43) Pub. Date: Jan. 3, 2019

(54) Domestic Food Preparation Apparatus for Dispensing a Liquid Fruit or Vegetable Product

(71) Applicants: Rosa Aguelo DE GUERO, London (GB); Peter WYNNE WILLSON, Chipping Norton Oxfordshire (GB)

(72) Inventors: Rosa Aguelo DE GUERO, London (GB); Peter WYNNE WILLSON, Chipping Norton Oxfordshire (GB)

(21) Appl. No.: 16/065,343

(22) PCT Filed: Dec. 23, 2016
(86) PCT No.: PCT/GB2016/054072

§ 371 Date: Jun. 22, 2018

(30) Foreign Application Priority Data
Dec. 23, 2015 (GB) 1522847.1

(51) Int. Cl. A47J 19/02; A47J 19/06; A47J 43/046

(52) U.S. Cl. CPC A47J 19/027; A47J 43/046; A47J 19/06

(57) ABSTRACT

Domestic food preparation apparatus has a supporting structure (10); a water inlet port for connection with a domestic water supply; a waste outlet port for connection with domestic water drainage; a fruit and/or vegetable aperture; at least one dispensing port (18); a waste; a blender (12) adapted through blending action to deliver a liquid fruit and/or vegetable product to the dispensing port (18) and/or a juice extractor (14)) adapted through extraction action to deliver product to the dispensing port (18) and peel, pith or the like to the waste inlet; and a cleaning system receiving water from the water inlet port and operable in continuous and/or intermittent mode to clean fruit or vegetable debris from the blender (12) or juice extractor (14) and deliver waste water and debris to the waste.

This invention relates to apparatus for food preparation, particularly in the domestic environment which term is here used to include social and consumer facing environments.

Freshly prepared fruit and vegetable juices are very popular, together with blended products which include some or all of the skin, pith, stalk or core of the fruit or vegetable. Such blended products are colloquially referred to as “smoothies”. To enable these products to be produced in the home, there is a growing domestic desire for blenders, juicers and citrus presses. Kitchen work-surfaces often exhibit a collection of such machines, but many of these are used rarely if at all.

It can be surmised that part of the reason why these machines are under-used is the manual effort required in the clean-up. A lack of familiarity in the techniques of using each machine may also be a disincentive.

Some retail establishments exist solely or largely to sell portions of juices or smoothies. Typically, these establishments use essentially domestic style equipment, possibly manufactured to more rugged standards. The juices or smoothies are typically freshly prepared in a goblet which must be cleaned by hand before re-use.

It is an object of this invention to provide improved domestic food preparation apparatus for dispensing a liquid fruit or vegetable product.

Accordingly, the present invention consists in one aspect in domestic food preparation apparatus comprising: a supporting structure; a water inlet port for connection with a domestic water supply; a waste outlet port for connection with domestic water drainage; at least one fruit and/or vegetable aperture for receiving fruit or vegetables; at least one dispensing port for dispensing a liquid fruit and/or vegetable product to the exterior of the supporting structure; a waste inlet communicating with a waste receptacle or a macerator having a macerator waste inlet, a macerator water inlet communicating with said water inlet port and a macerator waste outlet port for connection with said waste outlet port; at least one of: a blender adapted to receive fruit or vegetables through said aperture and through blending action to deliver a liquid fruit and/or vegetable product to said outlet port; and a juice extractor adapted to receive fruit or vegetables through said aperture and through extraction action to deliver a liquid fruit and/or vegetable product to said outlet port and peel, pith or the like to the waste inlet; and a cleaning system receiving water from the water inlet port and operable in continuous and/or intermittent mode to clean fruit or vegetable debris from the blender or juice extractor and deliver waste water and debris to the waste inlet or the waste outlet port.

The supporting structure may have a horizontal top surface and a vertical front surface; said at least one aperture being in the top surface or upper part of front surface; and said at least one dispensing port being in the top or front surface.

The or each dispensing port may be configured to enable an operator to position a one-portion container beneath the dispensing port to receive the liquid fruit and/or vegetable product.

The cleaning system may have a sterilisation mode, preferably in which steam is directed through at least working parts of the blender and/or juice extractor.

The apparatus may have a heater configured to cook or warm the liquid fruit and/or vegetable product prior to dispensing. A water filter (softener) and/or a carbonator may be in switched or continuous fluid communication with the water inlet port.

To simplify fluid flows, a valve arrangement may be connected to receive at least two different fluids selected from the group consisting of: cold water; hot water; steam water borne detergent, surfactant or disinfectant; room temperature air and heated air; there being a common conduit between the valve arrangement and the blender and/or a common conduit between the valve arrangement and the juice extractor, the or each common conduit configured to convey both different fluids.

The blender and/or the juice extractor may each have a working orientation in which working parts are enclosed and a cleaning orientation in which working parts are exposed in a cleaning chamber formed within the supporting structure; the cleaning system comprising a spray arrangement to spray water or other cleaning fluid through the cleaning chamber. A drive element can move each of the blender and/or the juice extractor between the working orientation and the cleaning orientation. The cleaning chamber may have a fluid tight door which can be opened for access to the blender and/or the juice extractor for maintenance. The blender and/or the juice extractor may ach have a prime mover coupled magnetically with working elements inside the cleaning chamber.

When a macerator is not present, the waste receptacle may be configured for collection of composting or for cooperation with a digester for the extraction of fuel.

One common dispensing port may be provided; alternatively a respective dispensing port is provided for the blender, the juice extractor and any other elements. The or each dispensing port is configured to enable the user (or operator in a retail outlet) to position a one-portion container beneath the dispensing port to receive the liquid fruit and/or vegetable product. The cleaning system additionally operates to rinse before dispensing of product.

One embodiment of the invention may be a free-standing or integrated product which combines in a single unit one or more of a: juicer, blender, citrus juicer, or other device for preparing a liquid fruit and/or vegetable product. As is well understood, a juicer will extract juice from a wide variety of fruits and vegetables, usually employing centrifugal action with a screen to retain solids. A blender will typically employ rotating blades with sufficient power to blend skin, pith, cores and similar solid material. A citrus juicer will normally use mechanical action to extract juice from a halved orange or grapefruit. The embodiment is plumbed into the domestic supply. It uses fresh water to flush away pulp during operation, and for rinsing during a cleaning cycle. A built-in macerator reduces peel and pulp and rinses to the utility drain. This arrangement allows for continuous operation with no need to empty out waste containers of pulp and peel; more importantly, the automatic cleaning cycle means there is no need for disassembly, manual cleanout and reassembly.

The invention will now be described by way of example with reference to the accompanying drawings, in which:

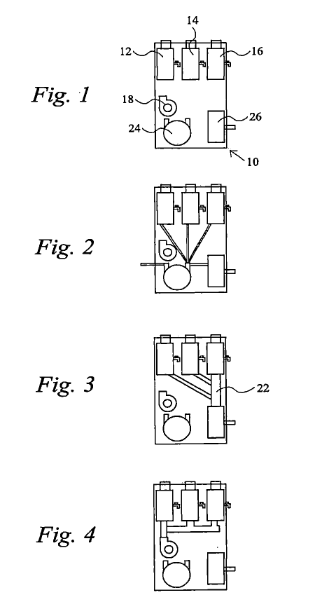

FIG. 1 is a somewhat diagrammatic sectional view of apparatus according to an embodiment of the invention;

FIG. 2 is a view similar to FIG. 1 illustrating fresh water distribution;

FIG. 3 is a view similar to FIG. 1 illustrating waste flows;

FIG. 4 is a view similar to FIG. 1 illustrating blown air distribution; and

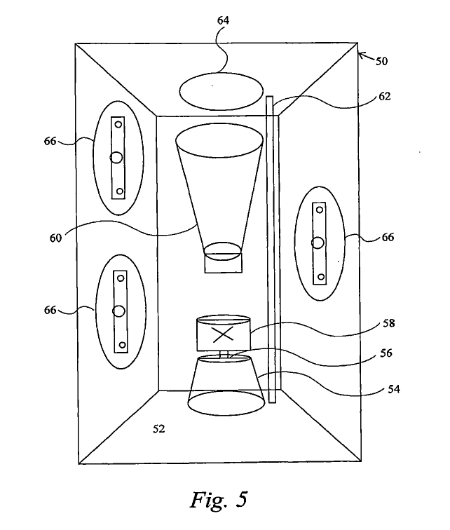

FIG. 5 is a somewhat diagrammatic sectional view of apparatus according to an embodiment of the invention

There is shown in FIGS. 1 to 4 a common support structure 10 for a blender 12; a juicer 14 and a citrus juicer 16. The design of each of these separate elements will be well understood by those skilled in the art. The structure includes a common enclosure. This may conform to standard sizing for floor standing kitchen units or white goods and may be full size or slim line. Ports for fresh water and drainage are provided in a rear surface. The blender, juicer and citrus juicer will open to the top (otherwise planar) surface or upper part of front surface of the enclosure for receiving fruit and vegetables. The dispensing ports 18 (or a common dispensing port) will be provided in the top or front surface, along with appropriate controls.

A push tool may be provided for the blender (or any element) to force fruit and vegetables (or pieces) through an entry aperture. This push tool may have a magnetic or other safety interlock. The juicer may have an “open” aperture designed to prevent splash back and/or a push tool with an optical or other safety interlock.

Included in the enclosure is a water pump 20 having an input for plumbing to the domestic water supply. As shown in FIG. 2, fresh water (which may pass through a water filter) is made available from the pump to each of the three devices as well as to the macerator 26. Filtered and non-filtered water supplies may be provided: filtered for water which will form part of the dispensed product.

A chute 22 seen in FIG. 3 transports citrus peel to the macerator. Similarly, ducts transport rinse water and any debris from the blender and the juicer to the macerator. A waste port enables connection to domestic waste drainage which may be part of an organic waste collection system communicating with a digester.

An air blower 24 (which may be heated) can provide drying air flows as shown in FIG. 4. The fresh water pump may have a low pressure side for flushing and a high pressure side for rinsing, or there may be provision for separate pumps for high and low pressure operations.

A control panel contains actuation switches for the separate elements, with appropriate safety interlocks. A switch may be used to manually activate the rinse cycle for one or more of the elements. Also, or alternatively, an automatic cleaning cycle may initiate, cleaning for example any used element within a defined period of use. Rinsing may be continuous in some cases. A touch panel may be provided in a top or front surface.

Examples of cycles of operation are set out below.

Before starting operation of any unit there may be a brief flush of fresh water to improve the subsequent rinse cycle.

### Blender

1. Blender's Rinse Cycle
a. Blender blades are activated for cleaning cycle.
b. Fresh water is fed to the cleaning jets, which is circulated by the active blades.
c. Rinse water drains via the spout into into a duct below the spout alcove, which leads to the macerator.
d. Drying cycle automatically follows the rinse cycle.

### Citrus Press

1. Citrus Press's Operational Peel Disposal
a. During operation, peel falls down a chute directly into the macerator.
b. Fresh water is fed directly to the macerator to enable maceration of the citrus peel and it's egress to the drain.

2. Citrus Press's Rinse Cycle
a. Fresh water is passed through a high pressure pump to the various cleaning jets positioned throughout the citrus press unit.
b. Waste water drains through to the macerator.
c. Drying cycle automatically follows the rinse cycle.

### Juicer

1. Juicer's Operational Pulp Flushing
a. During operation, fresh water is continuously fed to jets positioned in the pulp collection unit to flush the pulp slurry down the duct to the macerator.

2. Juicer's Rinse Cycle
a. Fresh water is passed through the high pressure pump to cleaning jets, which are positioned in the juicer's feeder tube, grater, screen, juice collection chamber, and pulp collection chamber.
b. Waste water drains through the spout, as well as the pulp drain into the macerator.
c. Drying cycle automatically follows the rinse cycle.

The example apparatus will include prime movers for the juicer, blender, citrus juicer, macerator (disposer), water pump(s) and drying fan(s). A control panel will have switches for the prime movers and switches for motorised valves (or actuators for manual valves) for fresh water for the disposal and cleaning cycle. Valves and jets will be provided for juicer pulp sluicing operations with manifolds for cleaning jets. Hoses & connectors will include fresh water inlet, interconnection hoses from unit to unit, outlet from macerator to utility drain, the macerator may have an integrated pump to assist final waste egress. There may be a cleaning brush option with one or more brushes for the juicer screen.

The support structure and enclosure may be of any convenient form.

In a modification, the macerator is replaced by a waste receptacle for composting fruit and vegetable waste. The waste may also be collected in a receptacle which forms part of an integrated domestic digester for the extraction of fuel.

The separate elements may have individual dispensing spouts; alternatively a common spout may be used. This would simplify the dispensing of hybrid drinks such as blended vegetables with citrus juice. In either case, provision may be made for drip capture and pre- or post-rinsing of the spout.

Another embodiment will now be described with reference to FIG. 5.

This shows apparatus including a blender; the same apparatus can of course also include a juice extractor and/or a citrus press. A supporting structure 50 defines a cleaning chamber 52. The blender comprises a motor 54 in a sealed housing. A magnetic coupling 56 is provided to the blender base 58 having conventional cutters. The motor can alternatively be provided outside cleaning chamber. A fruit or vegetable receiving goblet 60 is mounted on a lead screw 62 or other linear drive so as to be movable from a working configuration in which the base of the goblet seals with the blender base to the illustrated cleaning orientation in which the cutters are exposed. In the working configuration, the top of the goblet communicates with the aperture 64 in the supporting structure.

It will be apparent to the skilled man that the blender can be arranged to move from the working configuration to the cleaning orientation in many different ways. The same principles will apply to a juice extractor or citrus press provided in the same chamber, with variations to suit the different working parts.

There are rotating spray elements 66 provided in the cleaning chamber, together with a waste outlet (not shown). The cleaning chamber may also be provided with a fluid tight door which may be opened in an occasional maintenance phase.

The reader is directed to the field of domestic dish washers for more information on construction of the cleaning chamber and in particular on arrangements of spray elements which will ensure efficient cleaning of all working parts. Similarly, the apparatus may operate in rinsing, cleaning and drying phases as in a dishwasher.

It should be understood that this invention has been described by way of example only and that a wide variety of modifications are possible without departing from the scope of the appended claims.

In both embodiments there may be provided a heater configured to cook or warm the liquid fruit and/or vegetable product prior to dispensing. Particularly, vegetable soup may be dispensed.

A carbonator or separate supply of carbonated water may be provided to enable the dispensing of carbonated drinks.

1. Domestic food preparation apparatus comprising:
a supporting structure;
a water inlet port for connection with a domestic water supply;
a waste outlet port for connection with domestic water drainage;
at least one fruit and/or vegetable aperture for receiving fruit or vegetables;
at least one dispensing port for dispensing a liquid fruit and/or vegetable product to the exterior of the supporting structure;
a waste inlet communicating with a waste receptacle or a macerator having a macerator waste inlet, a macerator water inlet communicating with said water inlet port and a macerator waste outlet port for connection with said waste outlet port;
at least one of:
a blender adapted to receive fruit or vegetables through said aperture and through blending action to deliver a liquid fruit and/or vegetable product to said outlet port; and
a juice extractor adapted to receive fruit or vegetables through said aperture and through extraction action to deliver a liquid fruit and/or vegetable product to said outlet port and peel, pith or the like to the waste inlet; and
a cleaning system receiving water from the water inlet port and operable in continuous and/or intermittent mode to clean fruit or vegetable debris from the blender or juice extractor and deliver waste water and debris to the waste inlet or the waste outlet port.

2. Apparatus according to claim 1, wherein said supporting structure has a horizontal top surface and a vertical front surface; said at least one aperture being in the top surface or upper part of front surface; and said at least one dispensing port being in the top or front surface.

3. Apparatus according to claim 1, wherein the or each dispensing port is configured to enable an operator to position a one-portion container beneath the dispensing port to receive the liquid fruit and/or vegetable product.

4. Apparatus according to claim 1, comprising both of said blender and said juice extractor and optionally a citrus press.

5. Apparatus according to claim 1, wherein the waste receptacle is configured for cooperation with a digester for the extraction of energy.

6. Apparatus according to claim 1, wherein one common dispensing port is provided.

7. Apparatus according to claim 1, wherein the cleaning system additionally operates to rinse before dispensing of product.

8. Apparatus according to claim 1, wherein the cleaning system has a sterilisation mode, preferably in which steam is directed through at least working parts of the blender and/or juice extractor.

9. Apparatus according to claim 1, further comprising a heater configured to cook or warm the liquid fruit and/or vegetable product prior to dispensing.

10. Apparatus according to claim 1, further comprising at least one of a filter or a carbonator in switched or continuous fluid communication with the water inlet port.

11. Apparatus according to claim 1, comprising a valve arrangement connected to receive at least two different fluids selected from the group consisting of: cold water; hot water; steam water borne detergent, surfactant or disinfectant; room temperature air and heated air; there being a common conduit between the valve arrangement and the blender and/or a common conduit between the valve arrangement and the juice extractor, the or each common conduit configured to convey both different fluids.

12. Apparatus according to claim 1, wherein the blender and/or the juice extractor each have a working orientation in which working parts are enclosed and a cleaning orientation in which working parts are exposed in a cleaning chamber formed within the supporting structure; the cleaning system comprising a spray arrangement to spray water or other cleaning fluid through the cleaning chamber.

13. Apparatus according to claim 12, further comprising a drive element to move each of the blender and/or the juice extractor between the working orientation and the cleaning orientation.

14. Apparatus according to claim 12, wherein the cleaning chamber has a fluid tight door which can be opened for access to the blender and/or the juice extractor for maintenance.

15. Apparatus according to claim 1, wherein the blender and/or the juice extractor each have a prime mover coupled magnetically with working elements inside the cleaning chamber.
